(19) United States
(12) Patent Application Publication
(10) Pub. No.: US 2015/0089822 A1
(43) Pub. Date: Apr. 2, 2015

(54) Personal Grooming Device

(71) Applicants: Sheldon Reid, North Canton, OH (US); Francis Factora, North Canton, OH (US)

(72) Inventors: Sheldon Reid, North Canton, OH (US); Francis Factora, North Canton, OH (US)

(21) Appl. No.: 14/541,975

(22) Filed: Nov. 14, 2014

Related U.S. Application Data
(63) Continuation-in-part of application No. 13/848,147, filed on Mar. 21, 2013.
(60) Provisional application No. 61/614,023, filed on Mar. 22, 2012.

(51) Int. Cl. B26B 21/52; B26B 21/08

(52) U.S. Cl. CPC B26B 21/521; B26B 21/08; B26B 21/523; B26B 21/525; B26B 21/526
USPC 30/532

(57) ABSTRACT

Some embodiments may include a personal grooming device. Such a device may include a head portion. The head portion may include a means for mounting at least one razor. An embodiment may also include a means for rotating the razor clockwise and/or counterclockwise by a predefined number of degrees less than one full turn.

### I. REFERENCE TO RELATED APPLICATIONS

This application is a continuation-in-part claiming the benefit of pending, U.S. patent application Ser. No. 13/848,147 filed on Mar. 21, 2013 and is now pending, which in turn claims the benefit of US Provisional Patent Application No. 61/1614,023 filed on Mar. 22, 2012 which has expired, both of which are incorporated herein by reference in their entireties.

### II. BACKGROUND OF THE INVENTION

A. Field of Invention

One or more embodiments of the invention may generally relate to devices for grooming.

B. Description of the Related Art

It is known to use razor blades to trim body hair on, for instance, the face, legs, or head. Various devices are presently available for this purpose but all of certain shortcomings. For instance, a typical hand held non-electric razor it suitable for shaving the face, but is awkward to use for shaving the head. In part this is due to the need for holding the razor in un-natural positions in order to achieve an appropriate contact angle between the razor and the skin for an effective cut. Furthermore, one must not only hold known devices in awkward positions, but must also reposition the device, often blindly, so that all parts of the head can be accessed for shaving.

What is needed is a device which is more conveniently held and repositioned. One or more embodiments of the invention may overcome a shortcoming of the prior art.

### III. SUMMARY OF THE INVENTION

Some embodiments of the present invention relate to a

Other benefits and advantages will become apparent to those skilled in the art to which it pertains upon reading and understanding of the following detailed specification.

### VI. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view drawing of an embodiment;

FIG. 2 is a side-view of an embodiment;

FIG. 3 is an exploded view of a manual embodiment;

FIG. 4 is an exploded view of an electrical embodiment;

FIG. 5A is a drawing of an embodiment in a retracted configuration; and

FIG. 5B is a drawing of the embodiment of FIG. 5A in an extended configuration.

### V. DETAILED DESCRIPTION OF THE INVENTION

Embodiments of the invention generally relate to a personal grooming device for shaving parts of the body such as for instance, the head. In general, embodiments include an extendible handle portion terminating at one end in a head portion. A head portion typically includes at least one generally flat area adapted to support at least one mount for fixedly holding a disposable razor blade. Furthermore, embodiments can include a means for rotating a razor blade through a predetermined number of degrees, and may allow for quickly reversing t cutting direction of the razor blade.

A suitable handle portion can include a generally elongate structure having a first end and a second end, where one end terminates in a head portion. Some embodiments may include a contoured handle portion. For example, a contoured handle portion may be adapted to ergonomically fit the grip of an average user or of a specific user, and accordingly ma include one or more indentations for accommodating the digits of a user's hand. However, other embodiments may include a handle portion having any convenient shape such as a simple rectangular or circular cylindrical shape. Furthermore, embodiments may lack a handle entirely, and instead include a means for holding the head portion on a finger. For instance, a ring structure suitable for receiving a human finger may be used for holding and/or operating the device.

A suitable head portion can include a wide variety of shapes and contours provided they are suitable for cooperating with a mounting mechanism for fixedly attaching a disposable razor blade to the device. Non-limiting examples of suitable shapes for head portions include those having at least one generally flat surface suitable for cooperating with a mounting mechanism for presenting a mounted razor blade to a body surface in a cutting relation. In some embodiments a generally flat surface can include a contoured surface which is specially shaped to align a razor blade with a body surface. Furthermore, some embodiments can include a recessed mount for receiving a razor blade in a fixed relation recessed into the head portion.

Mechanisms for rotating disposable razor blades according to embodiments of the invention can include a wide variety of suitable means. For instance, embodiments may include purely mechanical means for rotating a razor blade which may be manually actuated and may or may not include a spring-loaded means. Alternatively, embodiments may include electrically powered means for rotating a razor blade such as a batter powered motor, solenoid, or other electromechanical means.

Furthermore, suitable handle portions and/or head portions are made from generally water-resistant materials such as organic polymer materials known in the art. For instance, polyolefins, polyesters, phenolic polymers, acrylonitrile butadiene styrene (ABS) polymers, polystrenes, polycarbonates, polyvinyl chlorides (PVC), polyamides, polyimides, polymelamines, polyurethanes, polyacetals, polyetheretherketones (PEEK), polyionomers, polybutylenes, polyphenylene oxides, or polyphenylene sulfides, or any combination thereof.

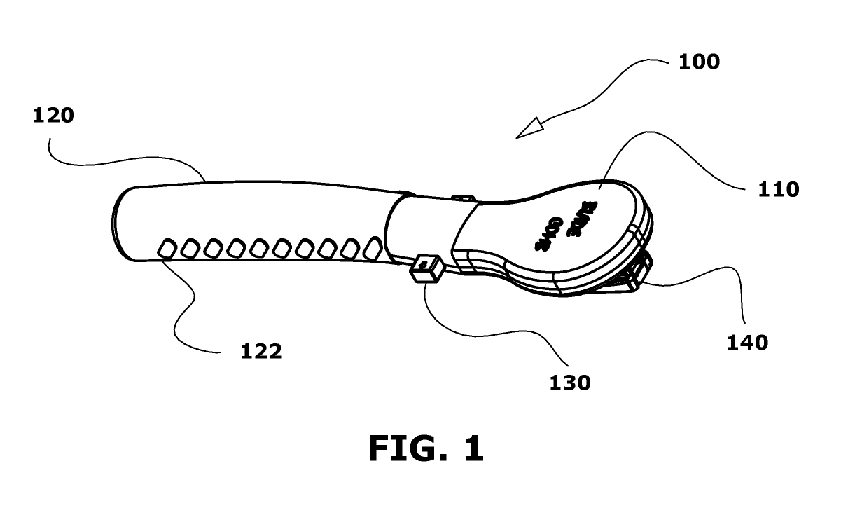

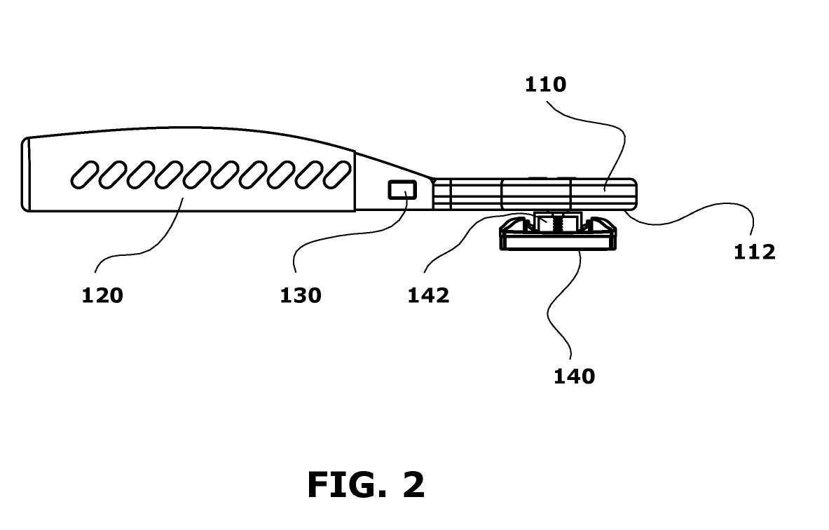

Referring now to the drawings wherein the showings are for purposes of illustrating embodiments of the invention only and not for purposes of limiting the same, FIG. 1 is a drawing of an embodiment 100 having a head portion 110 and a handle portion 120. The handle portion 120 includes a grip 122 adapted to promote non-slip handling of the embodiment 100. The embodiment also includes a razor blade 140 attached to a face of the embodiment 100. The razor 140 is adapted to rotate 180° in response to movement of a manually actuated lever 130. FIG. 2 shows the same embodiment from a side. The face 112 of the head portion 110 is visible in this view, along with a means for mounting 142 the razor 140 to the head portion 110. One skilled in the art will appreciate that the particular means for mounting can be selected from any of a wide variety of means known in the art. For example, and without limitation, appropriate means for mounting a razor 140 can include a releasable mechanism such as a spring-load releasable mechanism adapted to hold a razor 140 until/unless the spring force is overcome thereby releasing the razor 140. Other means may comprise, a permanent mount, wherein the overall device 100 comprises a disposable device.

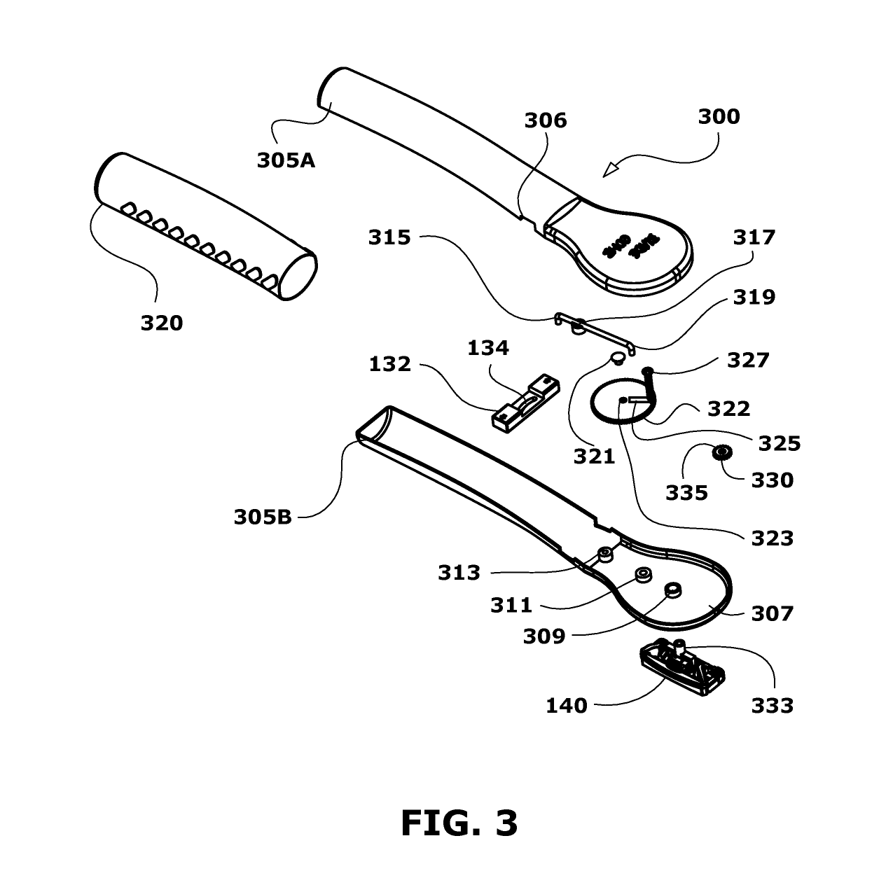

FIG. 3 is an exploded view of one particular embodiment 300. The embodiment 300 includes an upper enclosure 305A and a lower enclosure 305B. The grip 320 tits over the handle portion of the assembled. enclosure. The manually actuated lever 130 of FIG. 1 is shown to have a pair of tabs 132 which protrude from an aperture 306 on either side of the enclosure. The lever 130 also includes a recess 134 which is adapted to engage a first end 315 of a linkage. The linkage also has an off-center pivot point 317 which pivotally engages an annulus 313 formed upon an interior surface 307 of the lower enclosure 305B. The second end 319 of the linkage engages a slot 325 of a gear 322. The gear 322 is rotatably mounted by a pin 321 to an annulus 311 formed upon the interior surface 307 of the lower enclosure 305B.

Accordingly, depressing the tabs 132 causes the linkage to pivot about its pivot point 317, which results in the second end of the linkage 319 moving from side to side. This in turn causes the gear 322 to rotate. The particular embodiment illustrated in FIG. 3 also includes a planetary gear 330 having a central aperture 335. The mounting post 333 of the razor 140 is inserted into aperture 309 and protrudes into the interim of the enclosure. The portion of the mounting post 333 which clears the top edge of the aperture 309 engages the planetary gear 330 through its central aperture 335 in a press fit. The planetary gear 330 rotatably engages the gear 322, Which thus functions as a sun gear. Accordingly, rotation of the sun gear 322 causes rotation of the planetary gear 330 which in in turn rotates the razor 140.

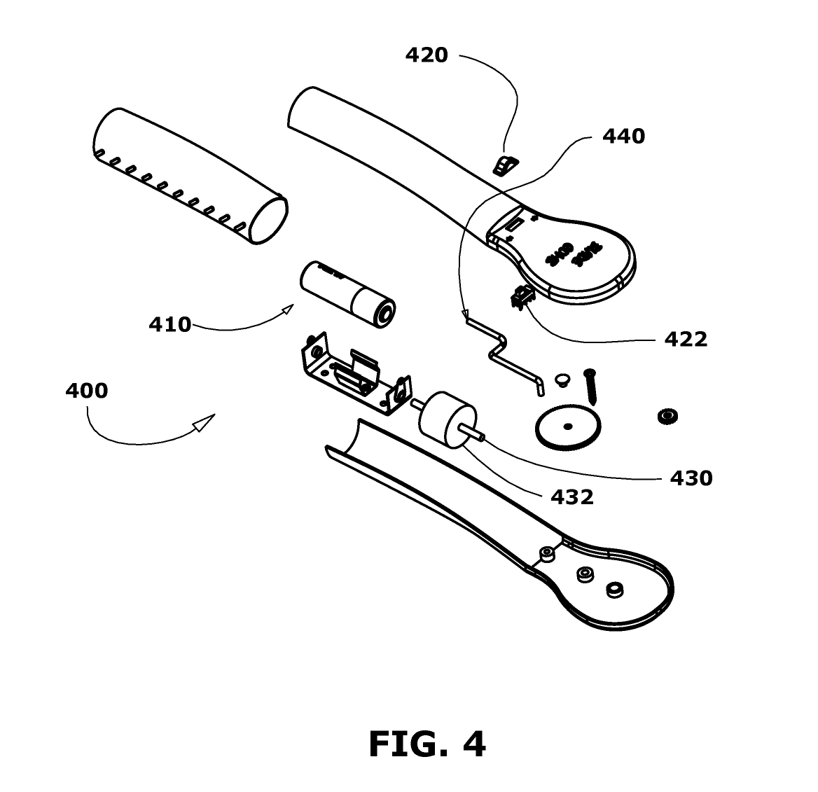

FIG. 4 illustrates an electrically powered embodiment 400. The embodiment of FIG. 4 is similar to that of FIG. 3 except for the replacement of certain manual components with electrical, alternatives. For example, the manually actuated lever 130 is replaced with a solenoid 430 which electrically communicates with a power supply 410 through a switch 422. The switch is conveniently fitted with a cap 420 to permit a user to easily operate the switch 422. Actuating the switch 422 either energizes or de-energizes the solenoid 432 depending on the position of the switch 422. For instance, depending on the state of the solenoid 432 the armature 430 may be extended or retracted. Furthermore, the armature 430 engages and mechanically cooperates with an end of a linkage 440. The linkage 440 of this embodiment behaves similarly to the linkage of FIG. 3 in its engagement of a planetary gear system to rotate a razor 140. Of course, it differs in that the linkage 440 of this embodiment 400 moves fore and aft rather than in a pivoting motion.

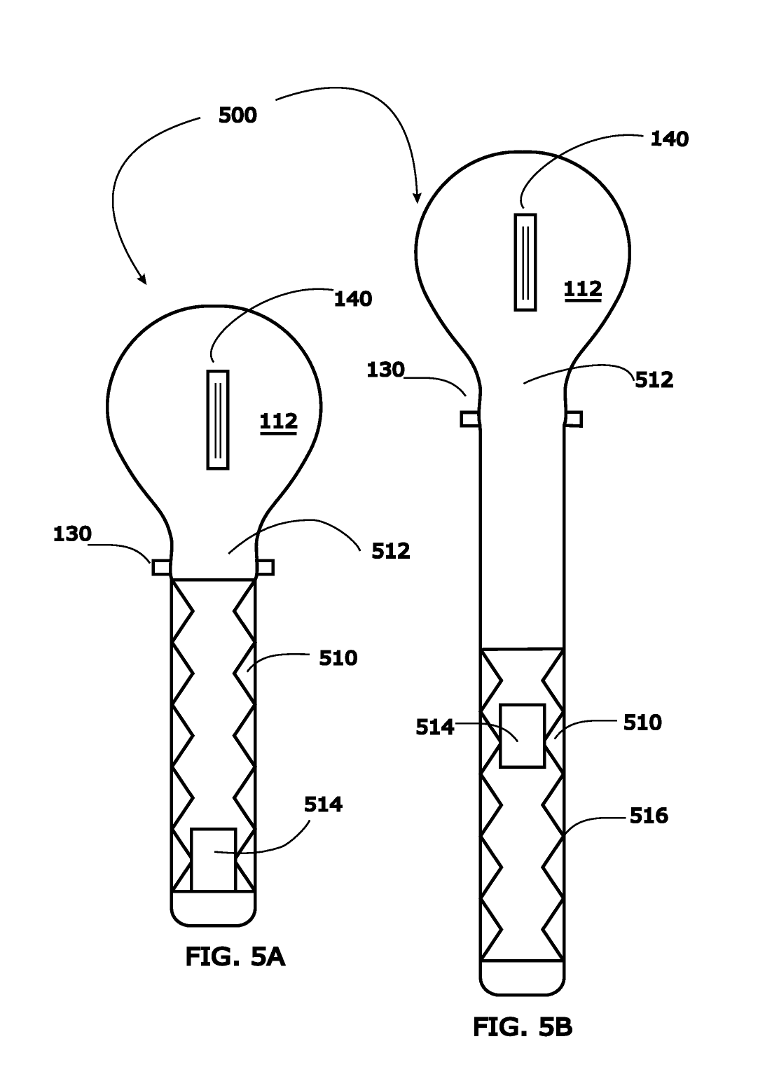

FIGS. 5A and 5B shows side-by-side views of an embodiment 500 having an extendible handle portion. As shown in FIG. 5A an inner handle 512 is retracted in inside of an outer handle 510. A user may slide the inner handle 512 using a protruding button 514 thus placing the embodiment in either an extended or retracted conformation. Furthermore, embodiments may include one or more mechanical stops which lock the inner handle into predetermined lengths. The embodiment 500 shown here. includes a box cutter-like slide with saw tooth shaped mechanical stops 516 which are engaged by the button 514 in a locking relation. Depressing the button 514 releases the locking relation and allows the inner handle 512 to be slid to a selected mechanical stop 516. Thus, the user may adjust the length of the embodiment 500 to enable one to reach certain areas of the body more easily. One skilled in the art will appreciate that the invention is not limited to the slide mechanism shown here. Rather, any slide mechanism known in the art may be substituted provided it allows a user to lock the embodiment at a selected length.

The embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

Having thus described the invention, it is now claimed:

1. A personal grooming device, comprising:
a head portion having a mount for releasably mounting a disposable razor blade; and
a means for rotating the disposable razor blade clockwise and/or counterclockwise by a predefined number of degrees less than one full turn.

2. The personal grooming device of claim 1, further comprising a handle portion defining a generally elongate structure having a first end and second end, wherein the first end fixedly engages, or is unitary with, the head portion.

3. The personal grooming device of claim 2, wherein the handle portion comprises an outer handle which receives an inner handle in a slidable relation, and wherein the handle portion includes a plurality of selectable mechanical stops adapted to reversibly lock the inner and the outer handles in a fixed relation relative to each other.

4. The personal grooming device of claim 1, wherein the means for rotating is adapted to rotate a disposable razor in steps from about 1 to 10 degrees, 10 to 20 degrees, 20 to 30 degrees, 30 to 40 degrees, 40 to 50 degrees, 50 to 60 degrees, 60 to 70 degrees, 70 to 80 degrees, 80 to 90 degrees, 90 to 100 degrees. 100 to 110 degrees. 110 to 120 degrees, 120 to 130 degrees. 130 to 140 degrees, 140 to 150 degrees, 150 to 160 degrees, 160 to 170 degrees, 170 to 180 degrees, 180 to 190 degrees, 190 to 200 degrees, 200 to 210 degrees, 210 to 220 degrees, 220 to 230 degrees, 230 to 240 degrees, 240 to 250 degrees, 250 to 260 degrees, 260 to .270 degrees, 270 to 280 degrees, 280 to 290 degrees, 290 to 300 degrees, 300 to 310 degrees, 310 to 320 degrees, 320 to 330 degrees, 330 to 340 degrees. 340 to 350 degrees, and/or about 350 to 359 degrees or any combination thereof.

5. The personal grooming device of claim 1, wherein the means for rotating is adapted to rotate a disposable razor in step of about 2, 3, 4, 5, 6, 7, 8, 0 and or about 10 degrees or any combination thereof.

6. The personal grooming device of claim 1, wherein the means for rotating includes:
a lever having a first end and second end and a pivot point between the first and second ends, the pivot point cooperating in a pivotable relation with an annulus on an internal surface of the head portion;
a manual switching means engaging the first end of the lever and adapted to rotate the lever about the pivot point; and
a first gear rotatably mounted to an interior surface of the head portion and adapted to engage and cooperate with the second end of the lever so that movement of the second end of the lever causes rotation of the first gear, and wherein the first gear mechanically cooperates with the means for mounting at least one razor to the head portion such that rotation of the first gear causes rotation of the means for mounting.

7. The personal grooming device of claim 6, further comprising a planetary gear rotatably engaging the first gear, wherein the planetary gear shares a central rotational axis with the means for mounting the at least one razor to the head portion.

8. The personal grooming device of claim 1, wherein the means for rotating includes:
an electrical power supply disposed on-board the device;
a solenoid mounted to an interior surface of the device and having a movable armature, the solenoid being in electrical communication with the power supply;
a manually actuated electrical switching means in electrical communication between the power supply and the solenoid, wherein the switching means is adapted to energize and de-energize the solenoid;
a first gear rotatably mounted to an interior surface of the head portion, wherein the first gear mechanically cooperates with the means for mounting at least one razor to the head portion such that rotation of the first gear causes rotation of the means for mounting; and
a linkage adapted to transmit movements of the armature to the first gear resulting in rotation of the first gear.

9. The personal grooming device of claim 8, further comprising a planetary gear rotatably engaging the first gear, wherein the planetary gear shares a central rotational axis with the means for mounting the at least one razor to the head portion.

10. A personal grooming device, comprising:
a head portion having a mount for releasably mourning a disposable razor blade; and
a means for rotating the disposable razor blade clockwise and/or counterclockwise by a predefined number of degrees less than one full turn;
a handle portion defining a generally elongate structure having a first end and second end, wherein the first end fixedly engages, or is unitary with, the head portion, wherein the handle portion comprises an outer handle which receives an inner handle in a slidable relation, and wherein the handle portion includes a plurality of selectable mechanical stops adapted to reversibly lock the inner and the outer handles in a fixed relation relative to each other.

11. The personal grooming device of claim 10, wherein the means for rotating is adapted to rotate a disposable razor in steps from about 1 to 10 degrees, 10 to 20 degrees, 20 to 30 degrees, 30 to 40 degrees, 40 to 50 degrees, 50 to 60 degrees, 60 to 70 degrees, 70 to 80 degrees, 80 to 90 degrees, 90 to 100 degrees, 100 to 110 degrees, 110 to 1 20 degrees, 120 to 130 degrees, 130 to 140 degrees, 140 to 150 degrees, 150 to 160 degrees, 160 to 170 degrees, 170 to 180 degrees, 180 to 190 degrees, 190 to 200 degrees, 200 to 210 degrees, 210 to 220 degrees, 220 to 230 degrees, 230 to 240 degrees, 240 to 250 degrees, 250 to 260 degrees, 260 to 270 degrees. 270 to 280 degrees, 280 to 290 degrees, 290 to 300 degrees, 300 to 310 degrees, 310 to 320 degrees, 320 to 330 degrees, 330 to 340 degrees. 340 to 350 degrees, and/or about 350 to 359 degrees or any combination thereof.

12. The personal grooming device of claim 11, wherein the means for rotating is adapted to rotate a disposable razor in step of about 1, 2, 3, 4, 5, 6, 7, 8, 9 and/or about 10 degrees or any combination thereof.

13. The personal grooming device of claim 10, wherein the means for rotating includes:
a lever having a first end an second end and a pivot point between the first and second ends, the pivot point cooperating in a pivotable relation with an annulus on an internal surface of the head portion;
a manual switching means engaging the first end of the lever and adapted to rotate the lever about the pivot point; and
a first gear rotatably mounted to an interior surface of the head portion and adapted to engage and cooperate with the second end of the lever so that movement of the second end of the lever causes rotation of the first gear, and wherein the first gear mechanically cooperates with the means fir mounting at least one razor to the head portion such that rotation of the first gear causes rotation of the means for mounting.

14. The personal grooming device of claim 13, further comprising a planetary gear rotatably engaging the first gear, wherein the planetary gear shares a central rotational axis with the means for mounting the at least one razor to the head portion.

15. The personal grooming device of claim 10, wherein the means for rotating includes:
an electrical power supply disposed on-board the device;
a solenoid mounted to an interior surface of the device and having a movable armature, the solenoid being in electrical communication with the power supply;
a manually actuated electrical switching means in electrical communication between the power supply and the solenoid, wherein the switching means is adapted to energize and de-energize the solenoid;
a first gear rotatably mounted to an interior surface of the head portion, wherein the first gear mechanically cooperates with the means for mounting at least one razor to the head portion such that rotation of the first gear causes rotation of the means for mounting; and
a linkage adapted to transmit movements of the armature to the first gear resulting in rotation of the first gear.

16. The personal grooming device of claim 15, further comprising a planetary gear rotatably engaging the first gear, wherein the planetary gear shares a central rotational axis with the means for mounting the at least one razor to the head portion.

17. A personal grooming device, comprising:
a head portion having a mount for releasably mounting a disposable razor blade; and
a means for rotating the disposable razor blade clockwise and/or counterclockwise by a predefined number of degrees less than one full turn, wherein the means for rotating includes:
(i) an electrical power supply disposed on-board the device;
(ii) a solenoid mounted to an interior surface of the device and having a movable armature, the solenoid being in electrical communication with the power supply;
(iii) a manually actuated electrical switching means in electrical communication between the power supply and the solenoid, wherein the switching means is adapted to energize and de-energize the solenoid;
(iv) a first gear rotatably mounted to an interior surface of the head portion, wherein the first gear mechanically cooperates with the means for mounting at least one razor to the head portion such that rotation of the first gear causes rotation of the means for mounting; and
(v) a linkage adapted to transmit movements of the armature to the first gear resulting in rotation of the first gear; and
a handle portion defining, a generally elongate structure having a first end and second end, wherein the first end fixedly engages, or is unitary with, the head portion, wherein the handle portion comprises an outer handle which receives an inner handle in a slidable relation, and wherein the handle portion includes a plurality of selectable mechanical stops adapted to reversibly lock the inner and the outer handles in a fixed relation relative to each other.
